(19) United States
(12) Patent Application Publication
(10) Pub. No.: US 2021/0383215 A1
(43) Pub. Date: Dec. 9, 2021

(54) VEHICLE, MODEL TRAINING SYSTEM AND SERVER

(71) Applicant: TOYOTA JIDOSHA KABUSHIKI KAISHA, Aichi-ken (JP)

(72) Inventors: Ryo NAKABAYASHI, Susono-shi (JP); Daiki YOKOYAMA, Gotemba-shi (JP); Hiroshi OYAGI, Gotemba-shi (JP)

(21) Appl. No.: 17/219,895

(22) Filed: Apr. 1, 2021

(30) Foreign Application Priority Data
Jun. 8, 2020 (JP) 2020-099370

(51) Int. Cl. G06N 3/08

(52) U.S. Cl. CPC G06N 3/08

(57) ABSTRACT

A vehicle includes a first communication device configured to communicate with a server that correlatively stores trained models of other vehicles and information relating to training conditions of the models of the other vehicles, and a first control device. The first control device is configured to transmit information relating to training conditions of a model of an own vehicle to the server. The first control device is configured to receive part of a model of a particular vehicle of which training conditions are closest to those of the model of the own vehicle, which has been selected from the models of the other vehicles stored in the server, as transfer-learning data. The first control device is configured to reuse part of the received model of the particular vehicle and perform training of the model of the own vehicle.

### CROSS-REFERENCE TO RELATED APPLICATION

This application claims priority to Japanese Patent Application No. 2020-099370 filed on Jun. 8, 2020, incorporated herein by reference in its entirety.

### BACKGROUND

### 1. Technical Field

The present disclosure relates to a vehicle, a model training system and a server.

### 2. Description of Related Art

Japan Unexamined Patent Application Publication No. 2019-183698 (JP 2019-183698 A) discloses a technique in which a trained model that has been trained at a server is transmitted to a vehicle, and temperature of an exhaust gas control catalyst of an internal combustion engine is estimated at the vehicle using the trained model.

### SUMMARY

As described in JP 2019-183698 A, computation resources are limited not only in a case where training is performed at a server but also in a case where training is performed in vehicles. Accordingly, there is demand for reducing the computation amount necessary for training and shortening the amount of time necessary for training.

The present disclosure provides a vehicle, a model training system and a server in which the computation amount necessary for training can be reduced, and the amount of time necessary for training can be shortened, with regard to creating a trained model.

A vehicle according to a first aspect of the present disclosure includes a first communication device configured to communicate with a server configured to correlatively store trained models of other vehicles trained at the other vehicles and information relating to training conditions of the models of the other vehicles, and a first control device configured to train a model of an own vehicle to be used in the vehicle. The first control device is configured to transmit information relating to training conditions of the model of the own vehicle to the server via the first communication device, when training the model of the own vehicle. The first control device is configured to receive at least part of a model of a particular vehicle, as transfer-learning data, from the server via the first communication device. Training conditions of the particular vehicle is equal to or close to the training conditions of the model of the own vehicle. The model of the particular vehicle is selected from the trained models of the other vehicles, the trained models are stored in the server, based on the information relating to the training conditions of the models of the other vehicles and the information relating to the training conditions of the model of the own vehicle. The first control device is configured to reuse at least part of the received model of the particular vehicle and perform training of the model of the own vehicle.

In the vehicle according to the first aspect of the present disclosure, the first control device may be configured to perform machine learning with regard to the model of the own vehicle.

In the vehicle according to the first aspect of the present disclosure, information relating to the training conditions may include information of hidden layers of neural networks constituting the model of the own vehicle and the models of the other vehicles.

In the vehicle according to the first aspect of the present disclosure, the transfer-learning data may be all or part of parameters of the hidden layers of the neural networks constituting the models of the other vehicles.

In the vehicle according to the first aspect of the present disclosure, information relating to the training conditions may include information unique to vehicles using the model of the own vehicle or the models of the other vehicles.

There may be provided a model training system including the vehicle according to the first aspect of the present disclosure, and the server. The server may be provided with a second communication device configured to communicate with the own vehicle and the other vehicles, a storage device configured to correlatively store the trained models of the other vehicles and the information relating to the training conditions of the models of the other vehicles, and a second control device. The second control device may be configured to select the model of the particular vehicle, based on the information relating to the training conditions of the models of the other vehicles and the information relating to the training conditions of the model of the own vehicle. The information relating to the training conditions of the models of the other vehicles may be stored in the storage device. The information relating to the training conditions of the model of the own vehicle may be received via the second communication device. The training conditions of the particular vehicle being equal to or close to the training conditions of the model of the own vehicle. The model of the particular vehicle may be one of the trained models of the other vehicles, the trained models may be stored in the storage device of the other vehicles.

In the model training system according to the second aspect of the present disclosure, the storage device may be configured to correlatively store the trained models of the vehicles and information relating to the training conditions of the trained models of the vehicles, received from the other vehicles.

A server according to a third aspect of the present disclosure includes a communication device configured to communicate with each of a plurality of vehicles, a storage device configured to correlatively store trained models trained at each of the vehicles and information relating to training conditions of the trained models of the vehicles and a control device. The control device is configured to receive, from one vehicle out of the vehicles, information relating to training conditions of a model of the one vehicle, via the communication device. The control device is configured to select a model of a particular vehicle, based on the received information relating to training conditions of the model of the one vehicle and the information relating to training conditions of the trained models of the vehicles. The information relating to training conditions of the trained models of the vehicles is stored in the storage device. The model of the particular vehicle is one of the trained models of the vehicles, the trained models are stored in the storage device. Training conditions of the particular vehicle are equal to or close to the training conditions of the one vehicle. The control device is configured to reuse at least part of the selected model of the particular vehicle and perform training of the model used at the one vehicle.

A server according to a fourth aspect of the present disclosure includes a communication device configured to communicate with each of a plurality of vehicles, and a first vehicle different from the vehicles, a storage device configured to correlatively store trained models trained at each of the vehicles, and information relating to training conditions of the trained models of the vehicles, and a control device. The control device is configured to receive, from the first vehicle, information relating to training conditions of a model of the first vehicle, via the communication device. The control device is configured to select a model of a particular vehicle, based on the received information relating to training conditions of the model of the first vehicle and the information relating to training conditions of the trained models of the vehicles. The information relating to training conditions of the trained models of the vehicles is stored in the storage device. The model of the particular vehicle is one of the trained models of the vehicles, the trained models are stored in the storage device, of the vehicles. Training conditions of the particular vehicle are equal to or close to the training conditions of the first vehicle. The control device is configured to reuse at least part of the model of the particular vehicle, and perform training of the selected model used at the first vehicle.

According to these aspects of the present disclosure, part of a trained model can be reused to create a trained model, and accordingly the computation amount necessary for training can be reduced and the amount of time necessary for training can be shortened.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic configuration diagram of a model training system according to an embodiment of the present disclosure;

FIG. 2 is a schematic view illustrating a hardware configuration of a vehicle;

FIG. 3 is a diagram illustrating an example of a neural network model;

FIG. 4 is a flowchart illustrating processing executed between a server and vehicles for aggregation of trained models at a server;

FIG. 5 is a flowchart illustrating processing executed between the server and the vehicles to perform transfer learning at the vehicles;

FIG. 6 is a diagram illustrating an example of transfer learning;

FIG. 7 is a diagram illustrating an example of transfer learning; and

FIG. 8 is a flowchart illustrating processing executed between the server and the vehicles to perform transfer learning at the server.

### DETAILED DESCRIPTION OF EMBODIMENTS

An embodiment of the present disclosure will be described in detail below with reference to the drawings. Note that in the following description, components that are the same are denoted by the same signs.

### First Embodiment

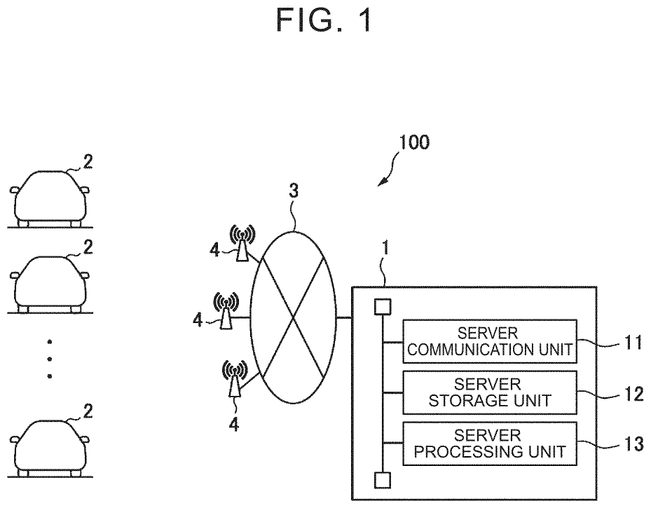

FIG. 1 is a schematic configuration diagram of a model training system 100 according to a first embodiment of the present disclosure.

The model training system 100 is provided with a server 1 and a plurality of vehicles 2, as illustrated in FIG. 1.

The server 1 is provided with a server communication unit 11, a server storage unit 12, and a server processing unit 13.

The server communication unit 11 has a communication interface circuit for connecting the server 1 to a network 3 via a gateway or the like for example, and is configured to be capable of mutual communication with the vehicles 2.

The server storage unit 12 has a storage medium such as a hard disk drive (HDD), an optical recording medium, semiconductor memory, or the like, and stores various types of computer programs, data, and so forth, used in processing by the server processing unit 13.

The server processing unit 13 has one or a plurality of processors and peripheral circuits thereof. The server processing unit 13 executes various types of computer programs stored in the server storage unit 12, and centrally controls the overall operations of the server 1. The server processing unit 13 is, for example, a central processing unit (CPU).

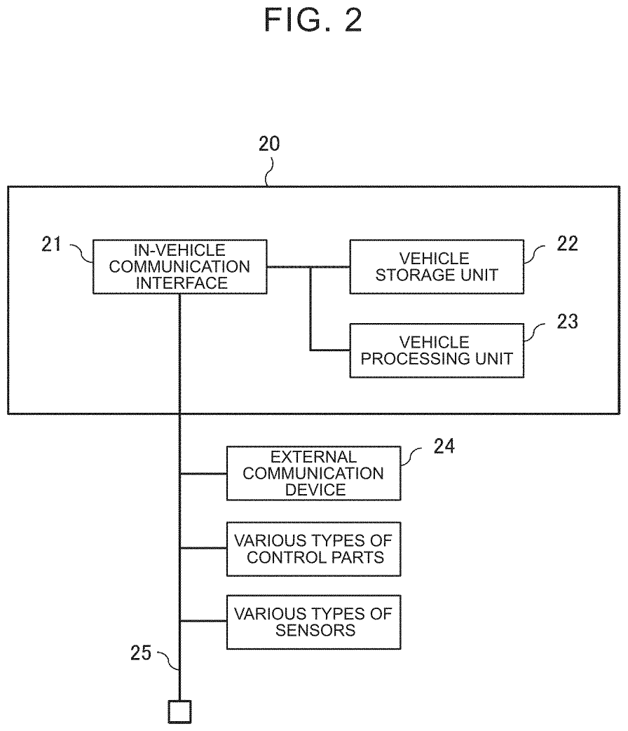

FIG. 2 is a schematic diagram illustrating a hardware configuration of the vehicle 2.

The vehicle 2 is provided with an electronic control unit 20, an external communication device 24, various types of control parts for the internal combustion engine and so forth, for example, and various types of sensors necessary for controlling the control parts. The electronic control unit 20, the external communication device 24, and the various types of control parts and sensors are mutually connected via an in-vehicle network 25 conforming to a standard such as Controller Area Network (CAN) or the like.

The electronic control unit 20 is provided with an in-vehicle communication interface 21, a vehicle storage unit 22, and a vehicle processing unit 23, which are connected to each other via a signal line. The electronic control unit 20 here is an example of a “first control device”.

The in-vehicle communication interface 21 is a communication interface circuit for connecting the electronic control unit 20 to the in-vehicle network 25 conforming to a standard such as CAN or the like.

The vehicle storage unit 22 has a storage medium such as an HDD, an optical recording medium, semiconductor memory, or the like, and stores various types of computer programs, data, and so forth, used for processing at the vehicle processing unit 23.

The vehicle processing unit 23 has one or a plurality of processors and peripheral circuits thereof. The vehicle processing unit 23 executes various types of computer programs stored in the vehicle storage unit 22, centrally controls various types of control parts installed in the vehicle 2, and is a CPU, for example.

The external communication device 24 is an onboard terminal that has wireless communication functions. The external communication device 24 is connected to the network 3 via a wireless base station 4 connected to the network 3 via a gateway or the like that is omitted from illustration, by accessing the wireless base station 4. Accordingly, mutual communication is performed with the server 1. The external communication device 24 here is an example of a “first communication device”.

In the vehicles 2, a trained artificial intelligence model (trained model) in which machine learning has been performed is used as necessary in the control of the various types of control parts installed in each of the vehicles 2. In the present embodiment, a neural network model (hereinafter referred to as “NN model”) using a deep neural network (DNN), a convolutional neural network (CNN), or the like, is used as an artificial intelligence model for carrying out deep learning of the NN model. Accordingly, the trained model according to the present embodiment can also be said to be a trained NN model that has been subjected to deep learning. Deep learning is one of machine learning methods that represent artificial intelligence (AI).

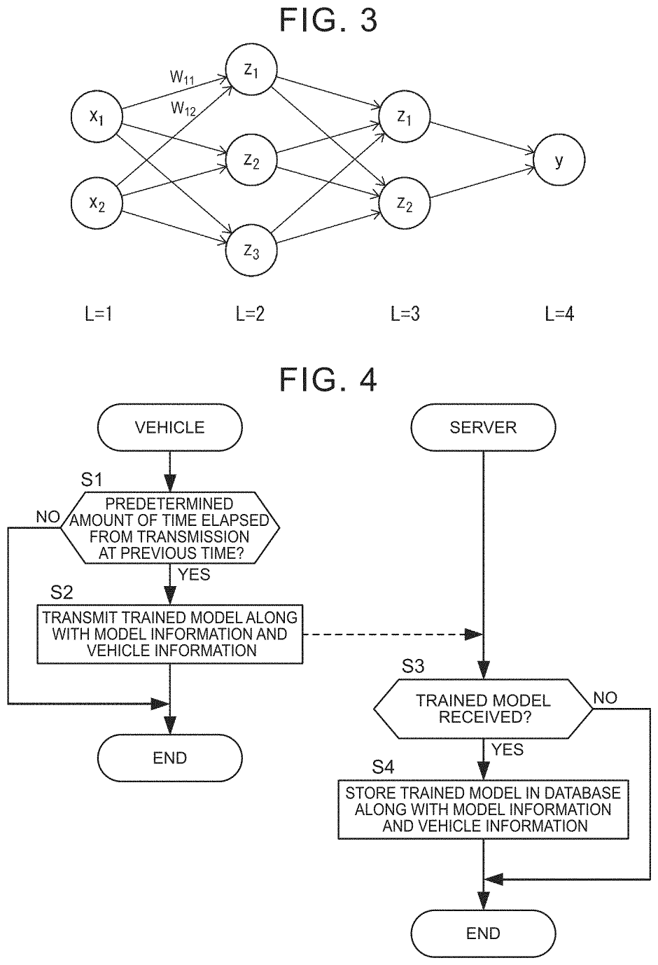

FIG. 3 is a diagram illustrating an example of an NN model.

The circles in FIG. 3 represent artificial neurons. Artificial neurons are normally referred to as “nodes” or “units” (referred to as “nodes” in the present specification). In FIG. 3, L=1 indicates an input layer, L=2 and L=3 represent hidden layers, and L=4 represents an output layer. The hidden layers are also referred to as intermediate layers. Although FIG. 3 exemplarily illustrates an NN model with two hidden layers, the number of hidden layers is not limited in particular. The numbers of nodes in each of the input layer, hidden layers, and output layers are not limited in particular, either.

In FIG. 3, x₁ and x₂ represent the nodes in the input layer (L=1) and the output values from these nodes, and y represents the node in the output layer (L=4) and the output value thereof. In the same way, z₁^{(L=2)}, z₂^{(L=2)}, and z₃^{(L=2)} represent the nodes in the hidden layer (L=2) and the output values of these nodes, and z₁^{(L=3)} and z₂^{(L=3)} represent the nodes in the hidden layer (L=3) and the output values of these nodes.

The inputs of each of the nodes in the input layer are output without change. On the other hand, the output values x₁ and x₂ of the nodes in the input layer are input to each of the nodes in the hidden layer (L=2), and a total input value u is calculated using respectively corresponding weight w and bias b at each of the nodes in the hidden layer (L=2). For example, a total input value uₖ^{(L=2)} calculated at each node expressed by zₖ^{(L=2)} (k=1, 2, 3) in the hidden layer (L=2) in FIG. 3 is as in the following expression (where M represents the number of nodes in the input layer).

$${u}_{k}^{( L = 2 )} = {\sum }_{m = 1}^{M} ( {x}_{m} \cdot {w}_{k m}^{( L = 2 )} ) + {b}_{k}$$

Next, this total input value uₖ^{(L=2)} is converted by an activation function f, and is output from the nodes expressed by zₖ^{(L=2)} in the hidden layer (L=2) as output value zₖ^{(L=2)}(=f(uₖ^{(L=2)})). On the other hand, the output values z₁^{(L=2)}, z₂^{(L=2)}, and z₃^{(L=2)} of each of the nodes in the hidden layer (L=2) are input to each of the nodes in the hidden layer (L=3), and the total input value u (=Σz·w+b) at each of the nodes in the hidden layer (L=3) is calculated using respectively corresponding weight w and bias b. The total input value u is converted by an activation function in the same way, and output from the nodes in the hidden layer (L=3) as output values z₁^{(L=3)} and z₂^{(L=3)}. The activation function is, for example, a sigmoid function σ.

The output values z₁^{(L=3)} and z₂^{(L=3)} of the nodes in the hidden layer (L=3) are input to the node in the output layer (L=4), and the total input value u (Σz·w+b) at the node in the output layer is calculated using respectively corresponding weight w and bias b, or the total input value u (Σz·w) is calculated using respectively corresponding weight w alone. For example, an identify function is used as an activation function at the node in the output layer. Here, the total input value u calculated at the node in the output layer is output from the node in the output layer without change, as output value y.

In this way, an NN model has an input layer, hidden layers, and an output layer, and when one or a plurality of input parameters are input from the input layer, one or a plurality of output parameters corresponding to the input parameters are output from the output layer.

Examples of input parameters regarding control of the internal combustion engine installed in the vehicle 2 using an NN model include current values of various types of parameters indicating the state of operation of the internal combustion engine, such as engine speed, engine coolant temperature, fuel injection amount, fuel injection timing, fuel pressure, intake air amount, intake temperature, exhaust gas recirculation (EGR) rate, supercharging pressure, and so forth. Examples of output parameters corresponding to such input parameters include estimated values of various types of parameters representing performance of the internal combustion engine, such as concentration of nitrogen oxides (NOx) and concentration of other substances in the exhaust, engine output torque, and so forth. Thus, inputting current values of various types of parameters indicating the state of operation of the internal combustion engine to the NN model as input parameters enables estimation values of various types of parameters representing performance of the internal combustion engine (current estimation values or future estimation values) to be obtained as output parameters. Accordingly, the internal combustion engine can be controlled based on the output parameters, for example, such that the performance of the internal combustion engine comes closer to the desired performance. Also, when sensors or the like are provided to measure the output parameters, malfunctioning of the sensors and the like can be determined in accordance with the difference between the measured values and the estimated values.

There is a need to train the NN model in order to improve precision of the NN model. A great number of training datasets, including measured values of input parameters, and measured values of output parameters (correct answer data) corresponding to the measured values of the input parameters, is used to train the NN model. The values of the weights w and the biases b within the neural network are repeatedly updated by known error backpropagation method, using the great number of training datasets. The values of the weights w and the biases b are thus learned, thereby a trained model is generated.

While the NN model can be trained at the server 1 or in the vehicles 2, computation resources for training are limited in either situation, and accordingly there is demand for reducing the computation amount necessary for training and shortening the amount of time necessary for training.

For example, at the server 1, when training an untrained NN model from the beginning, or when retraining a trained NN model, a conceivable arrangement is to perform training in which characteristics unique to each vehicle (e.g., vehicle type and vehicle specifications, user preferences, driving history, and so forth) are reflected to improve the estimation precision of the NN model, thereby creating a trained model optimized for each vehicle. However, this arrangement involves a tremendous number of models being trained, and accordingly there is demand to shorten the time required to train each NN model.

Also, when training and retraining of the NN model is performed in each vehicle 2, computation resources are particularly limited in the electronic control unit 20 installed in the vehicle 2, and accordingly there is demand for maximally reducing the computation amount and shortening the amount of time necessary for training.

Accordingly, in the present embodiment, from trained models of other vehicles aggregated at the server 1, a trained model that has training conditions closest to those of the own vehicle is selected. Then, transfer learning of the NN model of the own vehicle can then be performed based on part of the selected trained model of the other vehicle. Performing transfer learning reusing part of the trained model of another vehicle enables training in which only layers that identify characteristics unique to the vehicle, for example, and accordingly the NN model of the own vehicle can be trained with a small computation amount. Accordingly, the training time can be shortened regardless of whether a trained model optimized for each vehicle is created at the server 1, or a trained model is created at each of the vehicles 2. That is to say, a highly precise trained model optimized for each vehicle can be created in a short time. Accordingly, when the NN model is a model for estimating NOx concentration in the exhaust of the internal combustion engine, for example, driving with suppressed NOx concentration in the exhaust is enabled, and deterioration of exhaust emissions can be suppressed.

FIG. 4 is a flowchart illustrating processing that is executed between the server 1 and the vehicles 2, in order to aggregate trained models at the server 1.

In step S1, the electronic control unit 20 of the vehicle 2 determines whether a predetermined amount of time has elapsed since a trained model was transmitted to the server 1 the previous time, or not. When the predetermined amount of time has elapsed since a trained model was transmitted to the server 1 the previous time, the electronic control unit 20 advances to the processing in step S2. On the other hand, when the predetermined amount of time has not elapsed since a trained model was transmitted to the server 1 the previous time, the electronic control unit 20 ends the processing this time.

Note that in the present embodiment, the electronic control unit 20 acquires training data (e.g., measured values of engine speed and so forth as input parameters, and measured values of NOx concentration as output parameters) as necessary, and performs retraining of the trained NN model as necessary based on the acquired training data, while the vehicle is traveling. Thus, in the present embodiment, once the NN model is trained by transfer learning, the NN model is retrained by a small number of training datasets as necessary, instead of retraining the NN model using a great number of training datasets at a time. Thus, the computation load for retraining is suppressed, and the training time is shortened.

In step S2, the electronic control unit 20 of the vehicle 2 transmits, to the server 1, the current trained model correlated with predetermined model information and vehicle information. Examples of the model information include information unique to the model, such as the number of hidden layers of the trained model, the number of nodes in each hidden layer, and so forth. Examples of the vehicle information include information unique to each vehicle, such as vehicle type and vehicle specifications, distance traveled at the present (at the time of retraining), and so forth.

In step S3, the server 1 determines whether a trained model correlated with the model information and the vehicle information has been received, or not. When a trained model correlated with the model information and the vehicle information has been received, the server 1 advances to the processing of step S4. On the other hand, when a trained model correlated with the model information and the vehicle information has not been received, the server 1 ends the processing this time.

In step S4, the server 1 stores the received trained model in a model database formed in the server storage unit 12, along with the model information and the vehicle information.

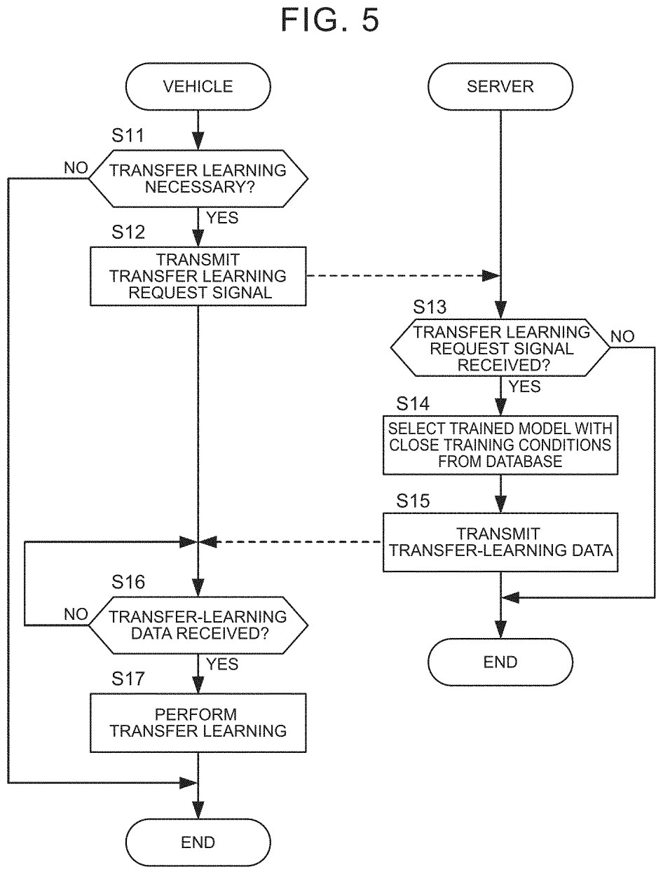

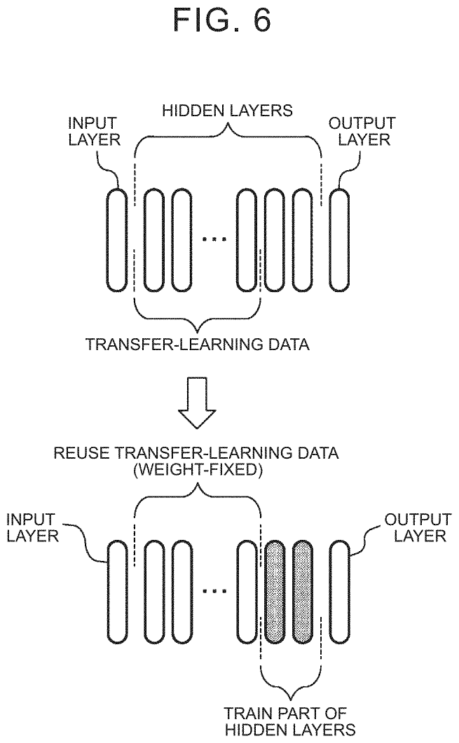

FIG. 5 is a flowchart illustrating processing carried out between the server 1 and the vehicles 2, to perform transfer learning at the vehicles 2. FIG. 6 is a diagram illustrating an example of transfer learning performed in the present embodiment. The upper part of FIG. 6 illustrates a trained model with close training conditions to those of the model of the own vehicle, which has been selected from within the model database. The lower part of FIG. 6 illustrates a trained model generated by transfer learning.

In step S11, the electronic control unit 20 of the vehicle 2 determines whether transfer learning is necessary, or not. In the present embodiment, the electronic control unit 20 determines that transfer learning is necessary the first time this processing is executed, such as when the own vehicle is shipped, for example. However, in addition to this, the electronic control unit 20 determines that transfer learning is necessary when a transfer learning request is made by the driver, and when the evaluation index is poor in comparison with other vehicles in the case where the model precision of the own vehicle can be evaluated by some sort of evaluation index (e.g., fuel consumption, exhaust emissions, etc.). When determining that transfer learning is necessary, the electronic control unit 20 advances to the processing of step S12. On the other hand, when determining that transfer learning is not necessary, the electronic control unit 20 ends the processing this time.

In step S12, the electronic control unit 20 of the vehicle 2 transmits a transfer learning request signal, including model information of the own vehicle (information unique to the model, such as the number of hidden layers of the NN model to be trained, the number of nodes in each hidden layer, and so forth), and vehicle information (information unique to the vehicle, such as vehicle type and vehicle specifications, distance traveled at the present, and so forth), to the server 1. Note that hereinafter, a vehicle 2 that transmits a transfer learning request signal to the server 1 will be referred to as a “transmission source vehicle” as necessary, for the sake of convenience. Here, a transmission source vehicle is an example of a “first vehicle”.

In step S13, the server 1 determines whether a transfer learning request is received, or not. When a transfer learning request is received, the server 1 advances to the processing of step S14. On the other hand, when a transfer learning request is not received, the server 1 ends the processing this time.

In step S14, the server 1 compares model information and vehicle information of trained models of other vehicles stored in the model database with the model information and the vehicle information of the transmission source vehicle, which have been received in step S12. Then, the server 1 selects a trained model of which the training conditions most closely match (equal to or the closest to) the transmission source vehicle from the trained models stored in the model database, as the trained model for transfer learning. Here, the selected trained model for transfer learning is an example of a “model of a particular vehicle”.

In the present embodiment, the server 1 quantifies the degree of matching of training conditions for each trained model stored in the model database, based on the items for determining the degree of matching of training conditions that are included in the model information and the vehicle information, such as the number of hidden layers and the number of nodes in each hidden layer, the vehicle type, the vehicle specifications, the distance traveled, and so forth. Thus, the server 1 selects the trained model with the highest degree of matching as the trained model for transfer learning.

For example, the server 1 quantifies the degree of matching regarding quantitative data such as the number of hidden layers and the number of nodes in each hidden layer, the distance traveled, and so forth, out of the items for determining the degree of matching of the training conditions, based on a weight set in advance for each item, and difference of each item (with regard to hidden layers for example, the difference between the number of hidden layers of the NN model of the transmission source vehicle and the number of hidden layers of each trained model). For example, considering the number of hidden layers alone, a trained model of another vehicle that has the same number of hidden layers as the number of hidden layers of the NN model of the transmission source vehicle will be the trained model with the highest degree of matching. Also, with regard to qualitative data such as vehicle type, vehicle specifications, and so forth, the server 1 determines the degree of matching (similarity) by cluster analysis for example, and quantifies the degree of matching.

In step S15, the server 1 transmits part of the trained model selected in step S14 to the transmission source vehicle as transfer-learning data to be used in transfer learning. In the present embodiment, the server 1 transmits data of part of the hidden layers at the side closer to the input layer (data of weights w and biases b corresponding to the nodes in the hidden layers, and so forth), out of the hidden layers of the trained model, to the transmission source vehicle as transfer-learning data, as illustrated in FIG. 6.

In step S16, the electronic control unit 20 of the vehicle 2 (transmission source vehicle) determines whether transfer-learning data has been received, or not. When transfer-learning data has been received, the electronic control unit 20 advances to the processing of step S17. On the other hand, when transfer-learning data has not been received, the electronic control unit 20 stands by for a predetermined amount of time, and determines again whether transfer-learning data has been received, or not.

In step S17, the electronic control unit 20 of the vehicle 2 (transmission source vehicle) performs transfer learning. In the present embodiment, the electronic control unit 20 reuses, without change, part of the hidden layers of the trained model of the other vehicle received as the transfer-learning data, and trains only part of the hidden layers of the NN model of the own vehicle by using training data, as illustrated in FIG. 6. Thus, the number of hidden layers for training can be reduced, and training can be performed using training data that is small as compared to a case of training the NN model of the own vehicle from the beginning. Accordingly, the computation amount necessary for training can be reduced, and the amount of time for training can be shortened.

Note that when there is training data that has been acquired and created at the own vehicle at the point in time when determination is made that transfer learning is necessary, this training data may be used as the training data. On the other hand, when there is nothing that has been acquired and created at the own vehicle, standardized training data may be prepared at the server 1 in advance, and this training data may be acquired from the server 1.

The vehicle 2 according to the present embodiment described above is provided with the external communication device 24 (first communication device) and the electronic control unit 20 (first control device). The external communication device 24 is communicable with the server 1 in which trained models of other vehicles (artificial intelligence models, e.g., NN models) trained at other vehicles, and information relating to training conditions of models of other vehicles are stored correlatively. The electronic control unit 20 trains a model of the own vehicle (artificial intelligence models, e.g., NN models) used in the own vehicle.

The electronic control unit 20 is configured so as to be provided with a transfer-learning data requesting unit and a training unit. The transfer-learning data requesting unit, when training the model of the own vehicle, transmits information relating to training conditions of the model of the own vehicle to the server 1 and requests transfer-learning data. When the training unit receives part of a model of another vehicle, of which the training conditions are equal to or close to the training conditions of the model of the own vehicle, and which is selected from trained models of other vehicles stored in the server 1 as transfer-learning data, based on the information relating to training conditions of the model of the other vehicle and the information relating to training conditions of the model of the own vehicle, the training unit reuses the received part of the model of the other vehicle and performs training (e.g., machine learning) of the model of the own vehicle.

Thus, training the model of the own vehicle by reusing part of a trained model of another vehicle without change enables the number of hidden layers for being trained to be reduced, and training can be performed using less training data as compared to when training the model of the own vehicle from the beginning. Accordingly, the computation amount necessary for training can be reduced, and the training time can be shortened. As a result, a highly precise trained model optimized for each vehicle can be created in a short time.

Note that in the present embodiment, information relating to training conditions includes information of hidden layers of neural networks constituting the model of the own vehicle and models of other vehicles (e.g., the number of hidden layers, the number of nodes in each hidden layer, and so forth). Also, in the present embodiment, the transfer-learning data is part of parameters of the hidden layer of the neural network constituting the models of the other vehicles.

Also, in the present embodiment, the information relating to training conditions includes information unique to vehicles which use the model of the own vehicle and the models of the other vehicles (e.g., vehicle type and vehicle specifications, distance traveled, and so forth).

Also, in the model training system 100 that is provided with such vehicles 2 and the server 1 described above, the server 1 includes the server communication unit 11 (second communication device) that is communicable with the plurality of vehicles 2, the server storage unit 12 (storage device) that correlatively stores trained models of other vehicles and the information relating to training conditions of the models of other vehicles and the server processing unit 13 (second control device).

In the present embodiment, the server processing unit 13 is configured to be provided with a selecting unit that selects a model of another vehicle, of which the training conditions are equal to or close to the training conditions of the model of the own vehicle, from models of other vehicles stored in the server storage unit 12, based on the information relating to training conditions of models of other vehicles stored in the server storage unit 12 and the received information relating to training conditions of the model of the own vehicle. The server processing unit 13 is also configured to correlatively store trained models of the vehicles 2 received from the plurality of vehicles 2, and the information relating to the training conditions of the trained models, in the server storage unit 12.

Although description has been made in the above first embodiment that training is performed in the electronic control unit 20 installed in the vehicle 2, transfer learning may be performed at the server processing unit 13, and the created trained model may be transmitted to the vehicle 2. Also, in the above first embodiment, the transmission source vehicle 2 transmits a transfer learning request, but the server 1 may determine that transfer learning is being requested when the server 1 receives the model information and the vehicle information of the vehicle. The server 1 may be programed to transmit transfer-learning data or a created trained model to the transmission source vehicles when the server 1 receives the model information and the vehicle information of the vehicle.

### Second Embodiment

Next, a second embodiment of the present disclosure will be described. In the present embodiment, when performing retraining of vehicles 2 stored in the server 1, transfer learning is performed at the server 1, and a trained model created hereby is transmitted to the vehicles 2.

FIG. 8 is a flowchart illustrating processing executed between the server 1 and the vehicles 2 to perform transfer learning at the server 1. Note that in FIG. 8, the contents of the processing of steps S11 through S14 are the same as the contents described above in the first embodiment, and accordingly description will be omitted here.

In step S21, the server 1 reuses part of the hidden layers of the trained model selected in step S14, without change, and trains the NN model of the transmission source vehicle using training data to create a trained model. The server 1 then transmits the created trained model to the transmission source vehicle.

In step S22, the electronic control unit 20 of the vehicle 2 (transmission source vehicle) determines whether a trained model has been received, or not. When a trained model has been received, the electronic control unit 20 advances to the processing of step S23, and when no trained model has been received, the electronic control unit 20 stands by for a predetermined amount of time, and determines again whether a trained model has been received, or not.

In step S23, the electronic control unit 20 of the vehicle 2 (transmission source vehicle) replaces the model of the own vehicle with the received trained model.

The server 1 according to the present embodiment described above is provided with the server communication unit 11 (communication device) communicable with each of the plurality of vehicles 2, the server storage unit 12 (storage device) that correlatively stores trained models trained at each of the plurality of vehicles 2 and information relating to training conditions of the models thereof, and the server processing unit 13 (control device).

The server processing unit 13 is configured to be provided with a selecting unit and a training unit. When the selecting unit receives, from one vehicle out of the plurality of vehicles 2, request signals for transfer-learning data including information relating to training conditions of the model used at the one vehicle, the selecting unit selects a trained model, of which the training conditions are equal to or close to the training conditions of the one vehicle, from trained models of the vehicles, based on the information relating to training conditions of the one vehicle and the information relating to training conditions of the vehicles stored in the server storage unit 12. The training unit reuses part of the selected trained model and trains the model to be used in the one vehicle.

Effects similar to those of the first embodiment can be yielded when transfer learning is performed at the server 1 in this way, as well. That is to say, when creating the trained model, the computation amount necessary for training can be reduced, and the amount of time necessary for training can be shortened.

Although description has been made in the above second embodiment that training is performed at the server processing unit 13 of the server 1, part of the selected trained model may be transmitted to the vehicles 2 as transfer-learning data and training may be performed at the electronic control unit 20 installed in the vehicle 2. Also, the server 1 receives a transfer learning request signal including the model information and the vehicle information of the transmission source vehicle from the electronic control unit 20 of the vehicle 2 in step S12 in the second embodiment, and the model of the transmission source vehicle may be included in the transfer learning request signal as well.

Although embodiments of the present disclosure have been described above, the above embodiments only show part of application examples of the present disclosure, and are not intended to limit the technical scope of the present disclosure to the specific configurations of the above embodiments.

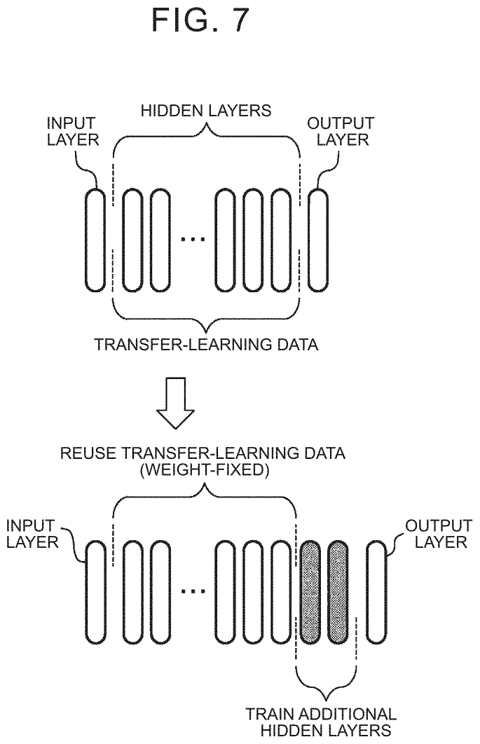

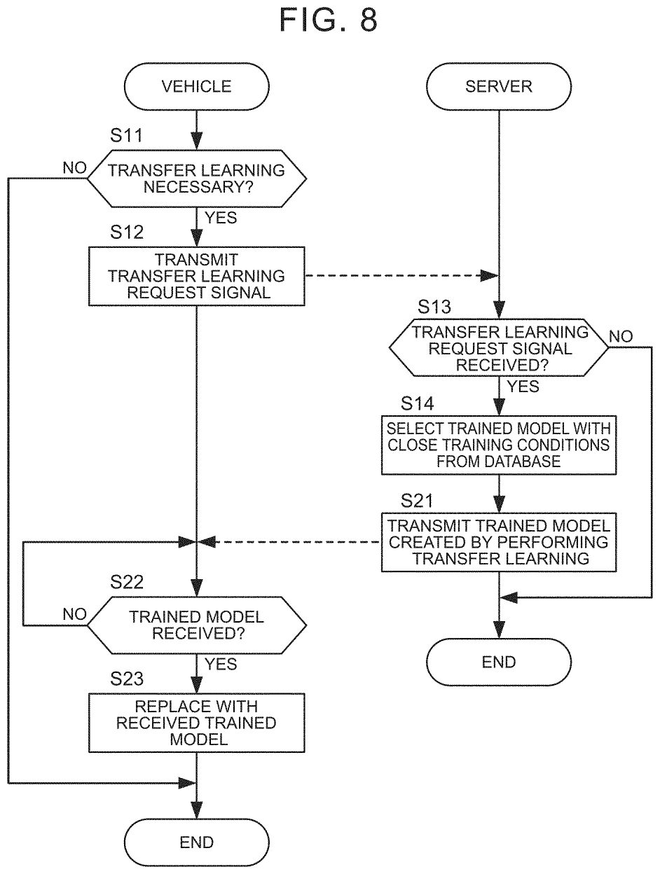

Description is made in the above embodiments that, for example, out of the hidden layers of the trained model selected from the model database, part of the data of the hidden layers on the side closer to the input layer is transmitted to the transmission source vehicle as transfer-learning data and transfer learning is performed, as illustrated in FIG. 6. However, all data of hidden layers of the trained model selected from the model database may be transmitted to the transmission source vehicle as transfer-learning data, as illustrated in FIG. 7, for example. Further, hidden layers may be separately added to all hidden layers of the trained model of the other vehicle received as transfer-learning data at the transmission source vehicle, and training may be performed regarding only the added hidden layers using training data. Note that the upper part of FIG. 7 illustrates a trained model with close training conditions to those of the model of the own vehicle, which has been selected from the model database, and the lower part of FIG. 7 illustrates a trained model generated by transfer learning.

Additionally, transfer learning may be performed by reusing only the weights w and the biases b relating to part of the nodes in the hidden layers. For example, when there are five nodes in a certain hidden layer, the weights w and the biases b regarding three nodes may be reused, training is performed for the weights w and the biases b regarding just the remaining two nodes.

What is claimed is:

1. A vehicle, comprising:
a first communication device configured to communicate with a server configured to correlatively store trained models of other vehicles trained at the other vehicles, and information relating to training conditions of the models of the other vehicles; and
a first control device configured to
train a model of an own vehicle to be used in the vehicle,
transmit information relating to training conditions of the model of the own vehicle to the server via the first communication device, when training the model of the own vehicle,
receive at least part of a model of a particular vehicle, as transfer-learning data, from the server via the first communication device, training conditions of the model of the particular vehicle being equal to or close to the training conditions of the model of the own vehicle, the model of the particular vehicle being selected from the trained models of the other vehicles, the trained models being stored in the server, based on the information relating to the training conditions of the models of the other vehicles and the information relating to the training conditions of the model of the own vehicle, and
reuse at least part of the received model of the particular vehicle and perform training of the model of the own vehicle.

2. The vehicle according to claim 1, wherein the first control device is configured to perform machine learning with regard to the model of the own vehicle.

3. The vehicle according to claim 1, wherein information relating to the training conditions includes information of hidden layers of neural networks constituting the model of the own vehicle and the models of the other vehicles.

4. The vehicle according to claim 3, wherein the transfer-learning data is all or part of parameters of the hidden layers of the neural networks constituting the models of the other vehicles.

5. The vehicle according to claim 1, wherein information relating to the training conditions includes information unique to vehicles using the model of the own vehicle or the models of the other vehicles.

6. A model training system comprising the vehicle according to claim 1 and the server, wherein the server is provided with:
a second communication device configured to communicate with the own vehicle and the other vehicles;
a storage device configured to correlatively store the trained models of the other vehicles and the information relating to the training conditions of the models of the other vehicles; and
a second control device configured to select the model of the particular vehicle, based on the information relating to the training conditions of the models of the other vehicles and the information relating to the training conditions of the model of the own vehicle, the information relating to the training conditions of the models of the other vehicles being stored in the storage device, the information relating to the training conditions of the model of the own vehicle being received via the second communication device, the training conditions of the model of the particular vehicle being equal to or close to the training conditions of the model of the own vehicle, and the model of the particular vehicle being one of the trained models of the other vehicles, the trained models being stored in the storage device.

7. The model training system according to claim 6, wherein the storage device is configured to correlatively store the trained models of the vehicles and information relating to the training conditions of the trained models of the vehicles, received from the other vehicles.

8. A server comprising:
a communication device configured to communicate with each of a plurality of vehicles;
a storage device configured to correlatively store trained models trained at each of the vehicles and information relating to training conditions of the trained models of the vehicles; and
a control device configured to
receive, from one vehicle out of the vehicles, information relating to training conditions of a model of the one vehicle via the communication device,
select a model of a particular vehicle, based on the received information relating to training conditions of the model of the one vehicle and the information relating to training conditions of the trained models of the vehicles, the information relating to training conditions of the trained models of the vehicles being stored in the storage device, the model of the particular vehicle being one of the trained models of the vehicles, the trained models being stored in the storage device, and training conditions of the model of the particular vehicle being equal to or close to the training conditions of the model of the one vehicle, and
reuse at least part of the selected model of the particular vehicle, and perform training of the model used at the one vehicle.

9. A server comprising:
a communication device configured to communicate with each of a plurality of vehicles, and a first vehicle different from the vehicles;
a storage device configured to correlatively store trained models trained at each of the vehicles, and information relating to training conditions of the trained models of the vehicles; and
a control device configured to
receive, from the first vehicle, information relating to training conditions of a model of the first vehicle, via the communication device;
select a model of a particular vehicle, based on the received information relating to training conditions of the model of the first vehicle and the information relating to training conditions of the trained models of the vehicles, the information relating to training conditions of the trained models of the vehicles being stored in the storage device, the model of the particular vehicle being one of the trained models of the vehicles, the trained models being stored in the storage device, and training conditions of the model of the particular vehicle being equal to or close to the training conditions of the model of the first vehicle; and
reuse at least part of the selected model of the particular vehicle, and perform training of the model used at the first vehicle.
